(19) United States
(12) Patent Application Publication
(10) Pub. No.: US 2022/0025212 A1
(43) Pub. Date: Jan. 27, 2022

(54) POLISHING COMPOSITION AND METHOD FOR POLISHING SYNTHETIC RESIN

(71) Applicant: FUJIMI INCORPORATED, Aichi (JP)

(72) Inventors: Hiroyuki ISHIDA, Aichi (JP); Ryo WAKABAYASHI, Aichi (JP)

(21) Appl. No.: 17/311,429

(22) PCT Filed: Dec. 12, 2019
(86) PCT No.: PCT/JP2019/048762

§ 371 Date: Jun. 7, 2021

(30) Foreign Application Priority Data
Dec. 14, 2018 (JP) 2018-234788
Sep. 30, 2019 (JP) 2019-179366

(51) Int. Cl. C09G 1/02

(52) U.S. Cl. CPC C09G 1/02

(57) ABSTRACT

There is provided a polishing composition which can be more suitably used for polishing a synthetic resin product or the like, and a polishing method for polishing a polishing object using a polishing composition. There is provided a polishing composition containing abrasives, 0.01% by mass or more and 15% by mass or less of a monovalent acid-aluminum salt, a pyrrolidone compound or a caprolactam compound, and water and having a pH of 7.0 or less.

### TECHNICAL FIELD

The present invention relates to a polishing composition, particularly a polishing composition suitable for polishing a synthetic resin product or the like, and a method for polishing a synthetic resin product or the like using a polishing composition.

### BACKGROUND ART

A polishing composition disclosed in PTL 1 contains abrasives containing alumina, a polishing removal accelerator containing aluminum nitrate, glycols, and the like, and water and is used for polishing a synthetic resin product or the like. A polishing composition disclosed in PTL 2 contains an aqueous dispersion of abrasives and a pyrrolidone compound or polyvinylcaprolactam and is used for polishing an organic polymer-based ophthalmic substrate.

These polishing compositions are required to have an ability to quickly polish a polishing object (i.e., high polishing ability). However, in the polishing composition of PTL 1, for example, the polishing ability is improved by increasing the amount of the alumina but a raw material cost increases and, when the particle diameter of the alumina is increased, the surface roughness of the polishing object after polishing is increased. When the amount of the aluminum nitrate is increased, problems of corrosion of a polishing machine and roughened hands occur. When the amount of the glycols is increased, the raw material cost increases as with the alumina. Also in the polishing composition of PTL 2, the polishing ability is improved but the surface properties of the polishing object after polishing or the stability of the polishing ability of the polishing composition are/is not elucidated.

### CITATION LIST

### Patent Literatures

PTL 1: JPH07-11239 A

PTL 2: JP 2008-537704 A (Translation of PCT Application)

### SUMMARY OF INVENTION

### Technical Problem

It is an object of the present invention to provide a polishing composition which can be suitably used, particularly a polishing composition which can be more suitably used for polishing a synthetic resin product or the like, and a polishing method for polishing a polishing object using a polishing composition.

### Solution to Problem

To achieve the above-described object, a polishing composition is provided which contains abrasives, 0.01% by mass or more and 15% by mass or less of a monovalent acid-aluminum salt, a pyrrolidone compound or a caprolactam compound, and water and which has a pH of 7.0 or less.

### Advantageous Effects of Invention

The present invention provides a polishing composition which can be suitably used, particularly a polishing composition which can be more suitably used for polishing a synthetic resin product or the like. Further, the present invention provides a polishing method for polishing a polishing object using such a polishing composition.

### DESCRIPTION OF EMBODIMENTS

A polishing composition according to one embodiment of the present invention contains abrasives, 0.01% by mass or more and 15% by mass or less of a monovalent acid-aluminum salt, a pyrrolidone compound or a caprolactam compound, and water and has a pH of 7.0 or less. Although polishing objects are not particularly limited, the polishing composition can be preferably used for polishing synthetic resins. The polishing composition is used for polishing semifinished products for obtaining synthetic resin substrates or synthetic resin products, for example. Examples of the synthetic resins include, but not particularly limited to, thermoplastic resins and thermosetting resins. Examples of the thermoplastic resins include acrylic resin (polymethylmethacryl), polycarbonate, polyimide, polystyrene, polyvinyl chloride, polyethylene, polypropylene, acrylonitrile/butadiene/styrene, acrylonitrile/styrene, polyvinyl alcohol, polyvinylidene chloride, polyethylene terephthalate, polyamide, polyacetal, polyphenylether, polybutylene terephthalate, ultrahigh molecular weight polyethylene, polyvinylidene fluoride, polysulfone, polyether sulfone, polyphenyl sulfide, polyallylate, polyamideimide, polyetherimide, polyetheretherketone, liquid crystal polymers, fluororesin (e.g., fully fluorinated resins, such as polytetrafluoroethylene (PTFE), partially fluorinated resins, such as polychlorotrifluoroethylene (PCTFE), polyvinylidene fluoride (PVDF), and polyvinyl fluoride (PVF), and fluorinated resin copolymers, such as perfluoroalkoxy fluororesin (PFA), ethylene tetrafluoride/propylene hexafluoride copolymer (FEP), ethylene/ethylene tetrafluoride copolymer (ETFE), and ethylene/chlorotrifluoroethylene copolymer (ECTFE)) and the like. Examples of the thermosetting resins include phenol resin, urea resin, melamine resin, unsaturated polyester, epoxy resin, silicon resin, polyurethane, and the like. Among the above, the polishing composition can be suitably used for polishing acrylic resin, polycarbonate resin, polyimide resin, fluororesin, and epoxy resin and more suitably used for polishing acrylic resin, polyimide resin, and epoxy resin.

Methods for molding the polishing objects are not particularly limited. Examples of methods for molding the thermoplastic resins include injection molding, blow molding, extrusion molding, T-die method, inflation method, vacuum molding, pressure molding, calendar molding, and the like. Examples of methods for molding the thermosetting resins include casting, vacuum molding, pressure molding, compression molding, press molding, hand lay-up, compression molding, press molding, injection molding, and the like. The polishing composition according to one embodiment of the present invention can be suitably used for polishing synthetic resins molded by these molding methods. Specifically, the polishing composition can remove defects, such as machining marks, or waviness generated in the synthetic resins molded or machined by these molding methods to obtain a low-defect, flat, and smooth surface.

The abrasives have a role of mechanically polishing the polishing objects. As the abrasives, particles containing oxides of silicon and metal elements, such as alumina, silica, cerium oxide, zirconia, titania, iron oxide, and manganese oxide are usable. Among the above, alumina and silica are suitable. Alumina may be any of α-alumina, δ-alumina, θ-alumina, κ-alumina, and amorphous alumina. Further, for example, in addition to the abrasives, such as alumina, at least one of colloidal silica, colloidal alumina, colloidal zirconia, colloidal titania, fumed silica, fumed alumina, fumed zirconia, fumed titania, silica sol, alumina sol, zirconia sol, titania sol, and the like may be contained. Colloidal metal oxides increase the viscosity of the polishing composition by being colloidally dispersed in the polishing composition. Thus, the dispersibility of the abrasives in the polishing composition is improved, so that the caking of the abrasives is suppressed. These metal oxides also suppress the aggregation of the abrasives in the polishing composition. Thus, the occurrence of scratches caused by the aggregated abrasives is suppressed.

The volume-based average particle diameter of the abrasives (hereinafter, sometimes referred to as “D50”) is not particularly limited and, in the case of alumina, for example, is preferably 0.1 μm or more and more preferably 0.2 μm or more. In the case of silica, 0.05 μm or more is preferable, 0.15 μm or more is more preferable, and 0.2 μm or more is still more preferable. In the ranges above, a high polishing removal rate can be achieved. From the viewpoint of the polishing removal rate, the volume-based average particle diameter of the abrasives is preferably 5 μm or less, more preferably 3 μm or less, and still more preferably 1.5 μm or less in the case of alumina, for example. In the case of silica, 1 μm or less is preferable and 0.5 μm or less is more preferable. From the viewpoint of the surface properties, 1.0 μm or less is preferable, 0.5 μm or less is more preferable, and 0.3 μm or less is still more preferable in the case of alumina, for example. In the case of silica, 0.3 μm or less is preferable, 0.25 μm or less is more preferable, and 0.2 μm or less is still more preferable. In the present invention, the volume-based average particle diameter indicates the cumulative median measured by a laser diffraction/scattering particle diameter distribution meter.

A 10% particle diameter in the volume-based cumulative particle diameter distribution of the abrasives (particle diameter at which the cumulative frequency from the small particle size side is 10%, hereinafter, sometimes referred to as “D10”) is preferably 0.05 μm or more, more preferably 0.1 μm or more, and still more preferably 0.15 μm or more in the case of alumina, for example. In the ranges above, a high polishing removal rate can be achieved. In the case of alumina, for example, D10 is preferably 1 μm or less, more preferably 0.7 μm or less, still more preferably 0.5 μm or less, yet still more preferably 0.3 μm or less, even yet still more preferably 0.25 μm or less, and most preferably 0.2 μm or less. In the ranges above, the surface properties are improved.

A 90% particle diameter in the volume-based cumulative particle diameter distribution of the abrasives (particle diameter at which the cumulative frequency from the small particle size side is 90%, hereinafter, sometimes referred to as “D90”) is preferably 0.15 μm or more, more preferably 0.2 μm or more, still more preferably 0.25 μm or more, and most preferably 0.3 μm or more in the case of alumina, for example. In the ranges above, a high polishing removal rate can be achieved. In the case of alumina, for example, D90 is preferably 8 μm or less, more preferably 3 μm or less, still more preferably 2 μm or less, yet still more preferably 1 μm or less, even yet still more preferably 0.6 μm or less, further more preferably 0.5 μm or less, and most preferably 0.4 μm or less. In the ranges above, the surface properties are improved.

A ratio of D90 to D50 (D90/D50) of the abrasives is preferably 1.1 or more and more preferably 1.2 or more in the case of alumina, for example. In the ranges above, a high polishing removal rate can be achieved. D90/D50 is preferably 2.5 or less, more preferably 1.7 or less, and still more preferably 1.5 or less in the case of alumina, for example. In the ranges above, the surface properties are improved.

A ratio of D90 to D10 (D90/D10) of the abrasives is preferably 1.2 or more, more preferably 1.3 or more, still more preferably 1.5 or more, and most preferably 1.7 or more in the case of alumina, for example. In the ranges above, a high polishing removal rate can be achieved. D90/D10 is preferably 6.5 or less, more preferably 3.0 or less, still more preferably 2.5 or less, and most preferably 2.1 or less in the case of alumina, for example. In the ranges above, the surface properties are improved.

A ratio of D50 to D10 (D50/D10) of the abrasives is preferably 1.1 or more and more preferably 1.2 or more in the case of alumina, for example. In the ranges above, a high polishing removal rate can be achieved. D50/D10 is preferably 2.0 or less, more preferably 1.8 or less, and still more preferably 1.6 or less in the case of alumina, for example. In the ranges above, the surface properties are improved.

The BET specific surface area of the abrasives is not particularly limited and is preferably 5 m²/g or more, more preferably 10 m²/g or more, and still more preferably 15 m²/g or more in the case of alumina, for example. 250 m²/g or less is preferable, 50 m²/g or less is more preferable, and 25 m²/g or less is still more preferable. In the ranges above, a high polishing removal rate can be achieved while keeping a good surface shape. The BET specific surface area can be measured using FlowSorb II 2300 manufactured by Micromeritex, for example. As gas to be adsorbed on the abrasives, nitrogen, argon, krypton, and the like are usable.

When alumina is used as the abrasives, the α-transformation rate thereof is not particularly limited and is preferably 30% or more, more preferably 40% or more, and still more preferably 50% or more. In the ranges above, a high polishing removal rate can be achieved while keeping a good surface shape. The α-transformation rate can be obtained from the integrated intensity ratio of the (113) plane diffraction line measured by X-ray diffraction measurement, for example.

The concentration of the abrasives contained in a polishing liquid of the present invention is not particularly limited and is usually preferably 0.1% by mass or more, more preferably 1% by mass or more, and still more preferably 3% by mass in the case of alumina, for example. In the case of silica, 0.1% by mass or more is preferable, 1% by mass or more is more preferable, and 3% by mass or more is still more preferable. In the ranges above, a high polishing removal rate can be achieved. The concentration of the abrasives is preferably 40% by mass or less, more preferably 20% by mass or less, and still more preferably 15% by mass or less in the case of alumina, for example. In the case of silica, 40% by mass or less is preferable, 30% by mass or less is more preferable, and 25% by mass or less is still more preferable. In the ranges above, a cost of the polishing composition is appropriate.

The monovalent acid-aluminum salt has a function as a polishing removal accelerator and a function of improving the surface quality of the surface to be polished. A polishing composition containing only a small amount of the monovalent acid-aluminum salt has a low polishing ability. Therefore, from the viewpoint of further surely improving the polishing ability of the polishing composition, the content of the monovalent acid-aluminum salt in the polishing composition needs to be 0.01% by mass or more and is preferably 2% by mass or more, more preferably 4% by mass or more, still more preferably more than 4% by mass, and most preferably 5% by mass or more. In contrast, even when a large amount of the monovalent acid-aluminum salt is contained, a sharp improvement of the performance of the polishing composition cannot be achieved, which is disadvantageous in terms of cost. Therefore, the content of the monovalent acid-aluminum salt is set to 15% by mass or less. These contents are contents excluding hydrated water, when the monovalent acid-aluminum salt contains the hydrated water. Preferable examples of the monovalent acid-aluminum salt include aluminum nitrate, aluminum chloride, and the like.

The polishing composition according to the above-described embodiment may contain inorganic acids, organic acids, or salts thereof in addition to aluminum nitrate as the polishing removal accelerator. Specific examples of the inorganic acids include phosphoric acid, nitric acid, sulfuric acid, hydrochloric acid, hypophosphorous acid, phosphonic acid, boric acid, sulfamic acid, and the like. Specific examples of the organic acids include citric acid, maleic acid, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, formic acid, oxalic acid, propionic acid, valeric acid, caproic acid, caprylic acid, capric acid, cyclohexanecarboxylic acid, phenylacetic acid, benzoic acid, crotonic acid, methacrylic acid, glutaric acid, fumaric acid, phthalic acid, isophthalic acid, terephthalic acid, glycolic acid, tartronic acid, glyceric acid, hydroxybutyric acid, hydroxyacetic acid, hydroxybenzoic acid, salicylic acid, isocitric acid, methylene succinic acid, gallic acid, ascorbic acid, nitroacetic acid, oxaloacetic acid, glycine, alanine, glutamic acid, asparaginic acid, valine, leucine, isoleucine, serine, threonine, cysteine, methionine, phenylalanine, tryptophan, tyrosine, proline, cystine, glutamine, asparagine, lysine, arginine, nicotinic acid, picolinic acid, methyl acid phosphate, ethyl acid phosphate, ethyl glycol acid phosphate, isopropyl acid phosphate, phytic acid, 1-hydroxyethylidene-1,1-diphosphonic acid, aminotri(methylenephosphonic acid), ethylenediamine tetra(methylenephosphonic acid), diethylenetriamine penta(methylenephosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, α-methylphosphonosuccinic acid, aminopoly(methylenephosphonic acid), methanesulfonic acid, ethanesulfonic acid, aminoethane sulfonic acid, benzene sulfonic acid, p-toluene sulfonic acid, 2-naphthalene sulfonic acid, and the like.

Examples of the salts include metal salts (e.g., alkali metal salts, such as lithium salt, sodium salt, and potassium salt), ammonium salts (e.g., quaternary ammonium salts, such as tetramethylammonium salt and tetraethylammonium salt), alkanolamine salts (e.g., monoethanolamine salt, diethanolamine salt, and triethanolamine salt), and the like of the above-described inorganic acids and organic acids. Specific examples of the salts include alkali metal phosphates and alkali metal hydrogen phosphates, such as tripotassium phosphate, dipotassium hydrogen phosphate, potassium dihydrogen phosphate, trisodium phosphate, disodium hydrogen phosphate, and sodium dihydrogen phosphate; alkali metal salts of the organic acids exemplified above; others, such as alkali metal salt of glutamic acid diacetate, alkali metal salt of diethylenetriamine pentaacetic acid, and alkali metal salt of hydroxyethyl ethylenediamine triacetic acid, and alkali metal salt of triethylenetetramine hexacetic acid; and the like. The alkali metals in the alkali metal salts can be, for example, lithium, sodium, potassium, and the like.

The polishing composition according to the above-described embodiment contains a pyrrolidone compound or a caprolactam compound as a water-soluble polymer. The weight average molecular weight of the water-soluble polymer is preferably 3,000 or more, more preferably 5,000 or more, still more preferably 10,000 or more, and most preferably 30,000 or more. This produces a technological effect of improving the dispersibility of a slurry. The weight average molecular weight of the water-soluble polymer is preferably 500,000 or less, more preferably 300,000 or less, and still more preferably 100,000 or less. This produces a technological effect of improving stability.

A suitable pyrrolidone compound used in the polishing composition according to the above-described embodiment is polyvinylpyrrolidone (hereinafter referred to as PVP). The weight average molecular weight of PVP used in a slurry composition in the present invention is preferably 3,000 or more and more preferably 10,000 or more. 60,000 or less is preferable and 50,000 or less is more preferable. PVP having weight average molecular weights in the ranges above is readily available from various chemical product suppliers.

Examples of the pyrrolidone compound include, as compounds other than PVP, N-octyl-2-pyrrolidone, N-dodecyl-2-pyrrolidone, N-methyl-2-pyrrolidone, N-ethyl-2-pyrrolidone, N-cyclohexyl-2-pyrrolidone, N-hydroxyethyl-2-pyrrolidone, N-butyl-2-pyrrolidone, N-hexyl-2-pyrrolidone, N-decyl-2-pyrrolidone, N-octadecyl-2-pyrrolidone, N-hexadecyl-2-pyrrolidone, and copolymers of polyvinylpyrrolidone, for example, and combinations thereof may be acceptable.

The content of the pyrrolidone compound in the slurry composition is preferably 0.01% by mass or more, more preferably 0.05% by mass or more, and still more preferably 0.1% by mass or more. 5% by mass or less is preferable, 2% by mass or less is more preferable, and 1% by mass or less is still more preferable. The pyrrolidone compound effectively acts for accelerating the polishing of synthetic resins by being contained together with the monovalent acid-aluminum salt.

The caprolactam compounds are nitrogen-containing organic compounds referred to as s-caprolactam, most of which is used in the production of nylon 6. Caprolactam is usable as a substitute for the pyrrolidone compounds. The content of the caprolactam compound is preferably 0.01% by mass or more, more preferably 0.05% by mass or more, and still more preferably 0.1% by mass or more in the slurry composition. 5% by mass or less is preferable, 2% by mass or less is more preferable, and 1% by mass or less is still more preferable. As a method for synthesizing s-caprolactam, a method including synthesizing cyclohexanone oxime from cyclohexanone, and converting the cyclohexanone oxime into s-caprolactam by Beckmann rearrangement is known as a major industrial method. As a method for synthesizing cyclohexanone oxime from cyclohexanone, a method is mentioned which includes, in manufacturing cyclohexanone oxime by reacting cyclohexanone, hydrogen peroxide, and ammonia with one another in the presence of a titanosilicate catalyst, taking out the used catalyst from the reaction system, and then carrying out a reaction using the used catalyst and an unused catalyst in combination, for example.

The polishing composition according to the above-described embodiment may contain other water-soluble polymers in addition to the pyrrolidone compounds or the caprolactam compounds as the water-soluble polymer. For example, polyalkylene oxide alkyl ether, glycols, such as ethylene glycol, diethylene glycol, triethylene glycol, polyethylene glycol, propylene glycol, dipropylene glycol, tripropylene glycol, and polypropylene glycol, cellulose derivatives, starch derivatives, polyacrylic acid, polyacrylamide, polyvinyl alcohol, polyethylene imine, polyalkylene oxide, and the like may be acceptable.

Water has a role as a medium for dispersing or dissolving components other than water in the polishing composition. The water may be industrial water, tap water, distilled water, or those obtained by filtering the same through a filter and preferably contains as little impurities as possible.

The pH of the polishing composition is 7.0 or less, preferably 6.0 or less, more preferably 5.0 or less, and still more preferably 4.5 or less. 2.0 or more is preferable and 2.3 or more is more preferable. From the viewpoint of improving the polishing ability, the pH is preferably 2.5 or more, more preferably 3.0 or more, and still more preferably 3.6 or more. 4.5 or less is preferable, 4.4 or less is more preferable, and 4.3 or less is still more preferable. When the pH of the polishing composition is in the ranges above, the polishing ability of the polishing composition is improved. From the viewpoint of stability against aging during long-term storage, 2.8 or more is preferable and 3.0 or more is more preferable. 3.6 or less is preferable and 3.4 or less is more preferable. When the pH of the polishing composition is in the ranges above, stable polishing performance over a long period of time can be maintained. The pH can be adjusted by adding the acids mentioned above or known alkali, such as potassium hydroxide, as appropriate.

The zeta potential of the polishing composition is preferably 0 mV or more. When the zeta potential of the polishing composition is in this range, the polishing ability of the polishing composition is improved and the stability of the polishing composition is improved.

When a polishing object is polished using the polishing composition, a polishing pad is pressed against the polishing object, and then, in that state, one of the polishing pad and the polishing object is slid to the other one while supplying the polishing composition to the polishing pad. When the temperature of the polishing composition supplied in polishing is excessively low, there is a risk that the polishing composition is frozen or a cooling cost for the polishing composition increases.

The polishing composition of the above-described embodiment may further contain antifoaming agents, antifungal agents, surfactants, anticorrosive agents, and the like.

The polishing composition according to the above-described embodiment may be prepared by manufacturing a stock solution for dilution at a concentration higher than the concentration in use, and diluting the stock solution for dilution with water. By manufacturing the stock solution for dilution at the concentration higher than the concentration in use, a transportation cost or a storage location of the polishing composition can be saved.

### EXAMPLES

Next, the present invention is more specifically described with reference to Examples and Comparative Examples.

### Example 1

In Examples 1-1 to 1-21, polishing compositions were prepared by mixing alumina, polyvinylpyrrolidone, 0.01% by mass or more and 15% by mass or less of a polishing removal accelerator which is a monovalent acid-aluminum salt, and water. The alumina, polyvinylpyrrolidone, and polishing removal accelerator contents in the polishing composition of each of Examples 1-1 to 1-21, the volume-based average particle diameter of the alumina, the weight average molecular weight of the water-soluble polymer, and the positive/negative of the zeta potential and the pH of each polishing composition are as shown in Table 1. In Comparative Examples 1-1 to 1-25, polishing compositions were prepared by mixing alumina, water-soluble polymers, polishing removal accelerators shown in Table 2, and water. The pH was adjusted by adding nitric acid or potassium hydroxide as appropriate. The volume-based average particle diameter of the alumina was measured with a laser diffraction/scattering particle diameter distribution meter LA-950 manufactured by HORIBA, Ltd. With respect to the zeta potential of each polishing composition, the positive/negative was measured with an electroacoustic-based high-concentration zeta potential meter ZetaProbe manufactured by Kyowa Interface Science Co., Ltd. The pH was measured with a pH meter F-72 manufactured by HORIBA, Ltd.

TABLE 1

| | | Abrasives | | | | |
|---|---|---|---|---|---|---|
| | | | | Particle | Water-soluble polymer | |
| | Polishing object | Type | Content | diameter | Compound name | Content |
| Ex. 1-1 | Acrylic resin | Alumina | 1 wt % | 0.25 um | Polyvinylpyrrolidone | 0.25 wt % |
| | | | | | (Mw: 45,000) | |
| Ex. 1-2 | Acrylic resin | Alumina | 5 wt % | 0.25 um | Polyvinylpyrrolidone | 0.25 wt % |
| | | | | | (Mw: 45,000) | |
| Ex. 1-3 | Acrylic resin | Alumina | 12.4 wt % | 0.25 um | Polyvinylpyrrolidone | 0.25 wt % |
| | | | | | (Mw: 45,000) | |
| Ex. 1-4 | Acrylic resin | Alumina | 18.0 wt % | 0.25 um | Polyvinylpyrrolidone | 0.25 wt % |
| | | | | | (Mw: 45,000) | |
| Ex. 1-5 | Acrylic resin | Alumina | 12.4 wt % | 0.25 um | Polyvinylpyrrolidone | 0.05 wt % |
| | | | | | (Mw: 45,000) | |
| Ex. 1-6 | Acrylic resin | Alumina | 12.4 wt % | 0.25 um | Polyvinylpyrrolidone | 0.15 wt % |
| | | | | | (Mw: 45,000) | |
| Ex. 1-7 | Acrylic resin | Alumina | 12.4 wt % | 0.25 um | Polyvinylpyrrolidone | 0.45 wt % |
| | | | | | (Mw: 45,000) | |
| Ex. 1-8 | Acrylic resin | Alumina | 12.4 wt % | 0.25 um | Polyvinylpyrrolidone | 1 wt % |
| | | | | | (Mw: 45,000) | |
| Ex. 1-9 | Acrylic resin | Alumina | 12.4 wt % | 0.25 um | Polyvinylpyrrolidone | 0.25 wt % |
| | | | | | (Mw: 5,000) | |
| Ex. 1-10 | Acrylic resin | Alumina | 12.4 wt % | 0.25 um | Polyvinylpyrrolidone | 0.25 wt % |
| | | | | | (Mw: 250,000) | |
| Ex. 1-11 | Acrylic resin | Alumina | 12.4 wt % | 0.25 um | Polyvinylpyrrolidone | 0.25 wt % |
| | | | | | (Mw: 45,000) | |
| Ex. 1-12 | Acrylic resin | Alumina | 12.4 wt % | 0.25 um | Polyvinylpyrrolidone | 0.25 wt % |
| | | | | | (Mw: 45,000) | |
| Ex. 1-13 | Acrylic resin | Alumina | 12.4 wt % | 0.25 um | Polyvinylpyrrolidone | 0.25 wt % |
| | | | | | (Mw: 45,000) | |
| Ex. 1-14 | Acrylic resin | Alumina | 12.4 wt % | 0.25 um | Polyvinylpyrrolidone | 0.25 wt % |
| | | | | | (Mw: 45,000) | |
| Ex. 1-15 | Acrylic resin | Alumina | 12.4 wt % | 0.25 um | Polyvinylpyrrolidone | 0.25 wt % |
| | | | | | (Mw: 45,000) | |
| Ex. 1-16 | Acrylic resin | Alumina | 12.4 wt % | 0.25 um | Polyvinylpyrrolidone | 0.25 wt % |
| | | | | | (Mw: 45,000) | |
| Ex. 1-17 | Acrylic resin | Alumina | 12.4 wt % | 0.25 um | Polyvinylpyrrolidone | 0.25 wt % |
| | | | | | (Mw: 45,000) | |
| Ex. 1-18 | Acrylic resin | Alumina | 12.4 wt % | 0.25 um | Polyvinylpyrrolidone | 0.25 wt % |
| | | | | | (Mw: 45,000) | |
| Ex. 1-19 | Acrylic resin | Alumina | 12.4 wt % | 0.25 um | Polyvinylpyrrolidone | 0.25 wt % |
| | | | | | (Mw: 45,000) | |
| Ex. 1-20 | Acrylic resin | Alumina | 12.4 wt % | 0.25 um | Polyvinylpyrrolidone | 0.25 wt % |
| | | | | | (Mw: 45,000) | |
| Ex. 1-21 | Acrylic resin | Alumina | 12.4 wt % | 0.25 um | Polyvinylpyrrolidone | 0.25 wt % |
| | | | | | (Mw: 45,000) | |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 1-1 | Aluminum nitrate | 5 wt % | 4.0 | + | 2.33 | A | — |
| Ex. 1-2 | Aluminum nitrate | 5 wt % | 4.0 | + | 3.34 | A | — |
| Ex. 1-3 | Aluminum nitrate | 5 wt % | 4.0 | + | 3.80 | A | B |
| Ex. 1-4 | Aluminum nitrate | 5 wt % | 4.0 | + | 3.82 | A | — |
| Ex. 1-5 | Aluminum nitrate | 5 wt % | 4.0 | + | 2.24 | A | — |
| Ex. 1-6 | Aluminum nitrate | 5 wt % | 4.0 | + | 3.01 | A | — |
| Ex. 1-7 | Aluminum nitrate | 5 wt % | 4.0 | + | 4.30 | A | — |
| Ex. 1-8 | Aluminum nitrate | 4 wt % | 4.0 | + | 4.79 | A | — |
| Ex. 1-9 | Aluminum nitrate | 5 wt % | 4.0 | + | 2.02 | B | — |
| Ex. 1-10 | Aluminum nitrate | 5 wt % | 4.0 | + | 3.26 | B | — |
| Ex. 1-11 | Aluminum nitrate | 5 wt % | 2.0 | + | 3.25 | A | C |
| Ex. 1-12 | Aluminum nitrate | 5 wt % | 2.8 | + | 3.30 | A | B |
| Ex. 1-13 | Aluminum nitrate | 5 wt % | 3.2 | + | 3.47 | A | A |
| Ex. 1-14 | Aluminum nitrate | 5 wt % | 3.6 | + | 3.52 | A | B |
| Ex. 1-15 | Aluminum nitrate | 5 wt % | 4.3 | + | 3.60 | A | C |
| Ex. 1-16 | Aluminum nitrate | 5 wt % | 5.0 | + | 2.91 | B | C |
| Ex. 1-17 | Aluminum nitrate | 5 wt % | 6.0 | + | 2.70 | B | C |
| Ex. 1-18 | Aluminum nitrate | 2.5 wt % | 4.0 | + | 1.90 | B | — |
| Ex. 1-19 | Aluminum nitrate | 10 wt % | 4.0 | + | 5.40 | A | — |
| Ex. 1-20 | Aluminum nitrate | 15 wt % | 4.0 | + | 5.56 | A | — |
| Ex. 1-21 | Aluminum chloride | 5 wt % | 4.0 | + | 2.18 | A | B |

TABLE 2

| | | Abrasives | | | | |
|---|---|---|---|---|---|---|
| | | | | Particle | Water-soluble polymer | |
| | Polishing object | Type | Content | diameter | Compound name | Content |
| Comp. Ex. 1-1 | Acrylic resin | Alumina | 12.4 wt % | 0.25 um | — | 0 wt % |
| Comp. Ex. 1-2 | Acrylic resin | Alumina | 12.4 wt % | 0.25 um | Polyvinylpyrrolidone | 0.25 wt % |
| | | | | | (Mw: 45,000) | |
| Comp. Ex. 1-3 | Acrylic resin | Alumina | 12.4 wt % | 0.25 um | — | 0 wt % |
| Comp. Ex. 1-4 | Acrylic resin | Alumina | 12.4 wt % | 0.25 um | Polyvinylpyrrolidone | 0.25 wt % |
| | | | | | (Mw: 45,000) | |
| Comp. Ex. 1-5 | Acrylic resin | Alumina | 12.4 wt % | 0.25 um | Polyvinyl alcohol | 0.05 wt % |
| Comp. Ex. 1-6 | Acrylic resin | Alumina | 12.4 wt % | 0.25 um | Polvvinylmethylether | 0.25 wt % |
| Comp. Ex. 1-7 | Acrylic resin | Alumina | 12.4 wt % | 0.25 um | Polyethylene glycol | 0.25 wt % |
| | | | | | (Mw: 600) | |
| Comp. Ex. 1-8 | Acrylic resin | Alumina | 12.4 wt % | 0.25 um | Polyoxyethylene alkylether | 0.25 wt % |
| | | | | | (PO-EO) | |
| Comp. Ex. 1-9 | Acrylic resin | Alumina | 12.4 wt % | 0.25 um | Pullulan | 0.25 wt % |
| Comp. Ex. 1-10 | Acrylic resin | Alumina | 12.4 wt % | 0.25 um | Glycine | 0.25 wt % |
| Comp. Ex. 1-11 | Acrylic resin | Alumina | 12.4 wt % | 0.25 um | Linear alkylbenzene sulfonate | 0.25 wt % |
| | | | | | (anionic) | |
| Comp. Ex. 1-12 | Acrylic resin | Alumina | 12.4 wt % | 0.25 um | Carboxy methylamine amphoteric | 0.25 wt % |
| | | | | | surfactant (amphoteric) | |
| Comp. Ex. 1-13 | Acrylic resin | Alumina | 12.4 wt % | 0.25 um | Polyvinylpyrrolidone | 0.25 wt % |
| | | | | | (Mw: 45,000) | |
| Comp. Ex. 1-14 | Acrylic resin | Alumina | 12.4 wt % | 0.25 um | Polyvinylpyrrolidone | 0.25 wt % |
| | | | | | (Mw: 45,000) | |
| Comp. Ex. 1-15 | Acrylic resin | Alumina | 12.4 wt % | 0.25 um | Polyvinylpyrrolidone | 0.25 wt % |
| | | | | | (Mw: 45,000) | |
| Comp. Ex. 1-16 | Acrylic resin | Alumina | 12.4 wt % | 0.25 um | Polyvinylpyrrolidone | 0.25 wt % |
| | | | | | (Mw: 45,000) | |
| Comp. Ex. 1-17 | Acrylic resin | Alumina | 12.4 wt % | 0.25 um | Polyvinylpyrrolidone | 0.25 wt % |
| | | | | | (Mw: 45,000) | |
| Comp. Ex. 1-18 | Acrylic resin | Alumina | 12.4 wt % | 0.25 um | Polyvinylpyrrolidone | 0.25 wt % |
| | | | | | (Mw: 45,000) | |
| Comp. Ex. 1-19 | Acrylic resin | Alumina | 12.4 wt % | 0.25 um | Polyvinylpyrrolidone | 0.25 wt % |
| | | | | | (Mw: 45,000) | |
| Comp. Ex. 1-20 | Acrylic resin | Alumina | 12.4 wt % | 0.25 um | Polyvinylpyrrolidone | 0.25 wt % |
| | | | | | (Mw: 45,000) | |
| Comp. Ex. 1-21 | Acrylic resin | Alumina | 12.4 wt % | 0.25 um | Polyvinylpyrrolidone | 0.25 wt % |
| | | | | | (Mw: 45,000) | |
| Comp. Ex. 1-22 | Acrylic resin | Alumina | 12.4 wt % | 0.25 um | Polyvinylpyrrolidone | 0.25 wt % |
| | | | | | (Mw: 45,000) | |
| Comp. Ex. 1-23 | Acrylic resin | Alumina | 12.4 wt % | 0.25 um | Polyvinylpyrrolidone | 0.25 wt % |
| | | | | | (Mw: 45,000) | |
| Comp. Ex. 1-24 | Acrylic resin | Alumina | 12.4 wt % | 0.25 um | Polyvinylpyrrolidone | 0.25 wt % |
| | | | | | (Mw: 45,000) | |
| Comp. Ex. 1-25 | Acrylic resin | | 0 wt % | | Polyvinylpyrrolidone | 0.25 wt % |
| | | | | | (Mw: 45,000) | |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Comp. Ex. 1-1 | — | 0 wt % | 4.0 | + | 0.81 | D | A |
| Comp. Ex. 1-2 | — | 0 wt % | 4.0 | + | 1.24 | C | A |
| Comp. Ex. 1-3 | Aluminum nitrate | 5 wt % | 4.0 | + | 1.30 | B | B |
| Comp. Ex. 1-4 | Aluminum nitrate | 20 wt % | 4.0 | + | 4.95 | D | — |
| Comp. Ex. 1-5 | Aluminum nitrate | 5 wt % | 4.0 | + | 0.87 | C | — |
| Comp. Ex. 1-6 | Aluminum nitrate | 5 wt % | 4.0 | + | 0.93 | A | — |
| Comp. Ex. 1-7 | Aluminum nitrate | 5 wt % | 4.0 | + | 0.73 | B | — |
| Comp. Ex. 1-8 | Aluminum nitrate | 5 wt % | 4.0 | + | 0.64 | A | — |
| Comp. Ex. 1-9 | Aluminum nitrate | 5 wt % | 4.0 | + | 0.56 | A | — |
| Comp. Ex. 1-10 | Aluminum nitrate | 5 wt % | 4.0 | + | 1.47 | A | — |
| Comp. Ex. 1-11 | Aluminum nitrate | 5 wt % | 4.0 | + | 0.92 | C | — |
| Comp. Ex. 1-12 | Aluminum nitrate | 5 wt % | 4.0 | + | 1.65 | C | — |
| Comp. Ex. 1-13 | Aluminum sulphate | 5 wt % | 4.0 | + | 0.82 | A | — |
| Comp. Ex. 1-14 | Aluminum oxalate | 5 wt % | 4.0 | + | 3.59 | C | — |
| Comp. Ex. 1-15 | Aluminum phosphate | 5 wt % | 4.0 | + | 8.90 | D | — |
| Comp. Ex. 1-16 | Polyaluminum chloride | 5 wt % | 4.0 | + | Gelation | | |
| Comp. Ex. 1-17 | Sodium nitrate | 5 wt % | 4.0 | + | 0.84 | A | — |
| Comp. Ex. 1-18 | Potassium chloride | 5 wt % | 4.0 | + | 0.88 | C | — |
| Comp. Ex. 1-19 | Hydrogen peroxide | 5 wt % | 4.0 | + | 0.97 | C | — |
| Comp. Ex. 1-20 | Sodium hexametaphosphate | 5 wt % | 4.0 | + | 0.71 | B | — |
| Comp. Ex. 1-21 | Sodium polyacrylate | 5 wt % | 4.0 | + | 0.63 | B | — |
| Comp. Ex. 1-22 | Aluminum nitrate | 5 wt % | 8.0 | − | 0.52 | C | — |
| Comp. Ex. 1-23 | Aluminum nitrate | 5 wt % | 10.0 | − | 0.70 | D | — |
| Comp. Ex. 1-24 | Aluminum nitrate | 5 wt % | 12.0 | − | 1.01 | D | — |
| Comp. Ex. 1-25 | Aluminum nitrate | 5 wt % | 4.0 | + | 0.00 | B | — |

An acrylic resin was polished under the following polishing conditions using the polishing composition of each of Examples 1-1 to 1-21 and Comparative Examples 1-1 to 1-25.

Polishing object: Acrylic resin (Rockwell hardness M85)

Polishing machine: EJ-380IN manufactured by ENGIS JAPAN CORPORATION

Polishing pad: Suede pad N17 manufactured by Fujibo Ehime Co., Ltd.

Polishing pressure: 150 g/cm² (14.7 kPa)

Polishing time: 3 minutes Used amount of polishing composition: 45 ml Supply flow amount of polishing composition: 15 ml/min

The polishing removal rate of the acrylic resin was calculated from a weight difference before and after the polishing of the acrylic resin with an electronic balance XS205 manufactured by METTLER TOLEDO Co., Ltd. The obtained polishing removal rate values are shown in Tables 1 and 2. The surface properties were evaluated by observing the polished surface of the acrylic resin after the polishing with a laser microscope VK-X200 manufactured by KEYENCE CORPORATION, with 20× objective and 20× ocular lenses, and at an angle of observation of 528×705 μm. A case where no scratches are observed on the surface is indicated as A, a case where the number of scratches at the above-described viewing angle is 1 to 2 is indicated as B, a case where the number of scratches is 3 to 10 is indicated as C, and a case where the number of scratches is 11 or more is indicated as D.

With respect to the stability of the polishing composition, the polishing composition was stored in a High Temperature Mechanical Convection Oven with variable DK600T manufactured by Yamato Scientific co., ltd., warmed to 80° C. for 7 days, the polishing removal rates were measured, and then a change rate was calculated from the polishing removal rates before and after the storage. A case where the change rate of the polishing removal rate is within 10% is indicated as A, a case where the change rate is 10 to 20% is indicated as B, and a case where the change rate is 20% or more is indicated as C. Cases where the stability of the polishing composition was not evaluated are indicated as -.

As is clear from Table 1, in Examples 1-1 to 1-21 in which the polishing compositions obtained by mixing alumina, polyvinylpyrrolidone, 0.01% by mass or more and 15% by mass or less of a monovalent acid-aluminum salt, and water were used, the polishing removal rates exceeded 1.50 μm/min, and few scratches were observed and the surface properties were good. In Examples 1-3 and 1-12 to 1-14 in which the pH is in the range of 2.8 to 4.0, the stability of the polishing compositions was good. Particularly in Example 1-13 in which the pH is 3.2, the stability was extremely good. In contrast, as shown in Table 2, Comparative Examples 1-5 to 1-12 in which the water-soluble polymers were other than polyvinylpyrrolidone, Comparative Examples 1-1 and 1-3 free from water-soluble polymers, Comparative Examples 1-13 to 1-21 in which polishing removal accelerators are other than the monovalent acid-aluminum salt, Comparative Examples 1-1 and 1-2 free from polishing removal accelerators, Comparative Examples 1-4 in which the content of the monovalent acid-aluminum salt exceeds 15% by mass, Comparative Examples 1-22 to 1-24 in which the pH is higher than 7.0, and Comparative Examples 1-25 free from abrasives had results that the polishing removal rates are low or a large number of scratches were observed and the surface properties were not good. Surprisingly, Comparative Example 1-2 containing abrasives and polyvinylpyrrolidone had a polishing removal rate of 1.24 μm/min and Comparative Example 1-3 containing abrasives and the monovalent acid-aluminum salt had a polishing removal rate of 1.30 μm/min, whereas, it was able to be confirmed that a specifically high polishing removal rate of 3.80 μm/min was obtained in Example 1-3 in which polyvinylpyrrolidone and aluminum nitrate were mixed in addition to the abrasives.

### Example 2

In Example 2-1, a polishing composition was prepared by mixing silica, polyvinylpyrrolidone, 0.01% by mass or more and 15% by mass or less of a polishing removal accelerator which is a monovalent acid-aluminum salt shown in Table 3, and water. The silica, polyvinylpyrrolidone, and polishing accelerator contents in each polishing composition, the volume-based average particle diameter of alumina, the weight average molecular weight of the water-soluble polymer, and the positive/negative of the zeta potential and the pH of each polishing composition are as shown in Table 3.

In Comparative Examples 2-1 to 2-3, polishing compositions were prepared by mixing silica, water-soluble polymers, polishing removal accelerators shown in Table 3, and water. The pH was adjusted by adding nitric acid or potassium hydroxide as appropriate. The volume-based average particle diameter of the silica was measured with a laser diffraction/scattering particle diameter distribution meter LA-950 manufactured by HORIBA, Ltd. With respect to the zeta potential of the polishing composition, the positive/negative was measured with an electroacoustic-based high-concentration zeta potential meter ZetaProbe manufactured by Kyowa Interface Science Co., Ltd. The pH was measured with a pH meter F-72 manufactured by HORIBA, Ltd. The evaluation conditions were the same as those in Example 1, and the evaluation was performed.

TABLE 3

| | | Abrasives | | | | |
|---|---|---|---|---|---|---|
| | | | | Particle | Water-soluble polymer | |
| | Polishing object | Type | Content | diameter | Compound name | Content |
| Ex. 2-1 | Acrylic resin | Colloidal | 17.5 wt % | 0.2 um | Polyvinylpyrrolidone | 0.1 wt % |
| | | silica | | | (Mw: 45,000) | |
| Comp. Ex. 2-1 | Acrylic resin | Colloidal | 17.5 wt % | 0.2 um | — | 0 wt % |
| | | silica | | | | |
| Comp. Ex. 2-2 | Acrylic resin | Colloidal | 17.5 wt % | 0.2 um | Polyvinylpyrrolidone | 0.1 wt % |
| | | silica | | | (Mw: 45,000) | |
| Comp. Ex. 2-3 | Acrylic resin | Colloidal | 17.5 wt % | 0.2 um | — | 0 wt % |
| | | silica | | | | |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 2-1 | Aluminum nitrate | 5 wt % | 3.2 | + | 1.20 | A | A |
| Comp. Ex. 2-1 | — | 0 wt % | 3.2 | + | 0.41 | B | A |
| Comp. Ex. 2-2 | — | 0 wt % | 3.2 | 0 | 0.47 | B | A |
| Comp. Ex. 2-3 | Aluminum nitrate | 5 wt % | 3.2 | − | 0.50 | B | A |

As is clear from Table 3, in Example 2-1 in which the polishing composition obtained by mixing silica, polyvinylpyrrolidone, 0.01% by mass or more and 15% by mass or less of the monovalent acid-aluminum salt, and water was used, the polishing removal rate exceeded 1.00 μm/min, and few scratches were observed and the surface properties were good. In contrast, in Comparative Example 2-3 free from water-soluble polymers, Comparative Example 2-2 free from polishing removal accelerators, and Comparative Example 2-1 free from water-soluble polymers and polishing removal accelerators had results that the polishing removal rate was low and the evaluation of scratches was also slightly inferior to Example 2-1.

### Example 3

In Examples 3-1 and 3-2 and Comparative Examples 3-1 to 3-3, polishing compositions were prepared by mixing alumina, water-soluble polymers, polishing removal accelerators shown in Table 4, and water in the same manner as in Example 1. A polycarbonate resin was polished under the following polishing conditions using each of the obtained polishing compositions. The alumina, polyvinylpyrrolidone, monovalent acid-aluminum salt contents in each polishing composition, the volume-based average particle diameter of the alumina, the weight average molecular weight of the water-soluble polymer, the zeta potential and the pH of each polishing composition are shown in Table 4 as with Tables 1 and 2.

Polishing object: Polycarbonate resin (Rockwell hardness M70)

Polishing machine: EJ-380IN manufactured by ENGIS JAPAN CORPORATION

Polishing pad: Suede pad N17 manufactured by Fujibo Ehime Co., Ltd.

Polishing pressure: 150 g/cm² (14.7 kPa)

Polishing time: 3 minutes

Used amount of polishing composition: 45 ml

Supply flow amount of polishing composition: 15 ml/min

The polishing removal rate of the polycarbonate resin was calculated from a weight difference before and after the polishing of the polycarbonate resin with an electronic balance XS205 manufactured by METTLER TOLEDO Co., Ltd. The obtained polishing removal rate values are shown in Table 4. The surface properties were evaluated by observing the polished surface of the polycarbonate resin after the polishing with a laser microscope VK-X200 manufactured by KEYENCE CORPORATION, with 20× objective and 20× ocular lenses, and at an angle of observation of 528×705 μm. A case where no scratches are observed on the surface is indicated as A, a case where the number of scratches at the above-described viewing angle is 1 to 2 is indicated as B, a case where the number of scratches is 3 to 10 is indicated as C, and a case where the number of scratches is 11 or more is indicated as D. The stability of the polishing compositions was also evaluated in the same manner as in Example 1.

TABLE 4

| | | Abrasives | | | | |
|---|---|---|---|---|---|---|
| | | | | Particle | Water-soluble polymer | |
| | Polishing object | Type | Content | diameter | Compound name | Content |
| Ex. 3-1 | Polycarbonate | Alumina | 12.4 wt % | 0.25 um | Polyvinylpyrrolidone | 0.25 wt % |
| | resin | | | | (Mw: 45,000) | |
| Ex. 3-2 | Polycarbonate | Alumina | 12.4 wt % | 0.25 um | Polyvinylpyrrolidone | 0.25 wt % |
| | resin | | | | (Mw: 45,000) | |
| Comp. Ex. 3-1 | Polycarbonate | Alumina | 12.4 wt % | 0.25 um | — | 0 wt % |
| | resin | | | | | |
| Comp. Ex. 3-2 | Polycarbonate | Alumina | 12.4 wt % | 0.25 um | Polyvinylpyrrolidone | 0.25 wt % |
| | resin | | | | (Mw: 45,000) | |
| Comp. Ex. 3-3 | Polycarbonate | Alumina | 12.4 wt % | 0.25 um | — | 0 wt % |
| | resin | | | | | |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 3-1 | Aluminum nitrate | 5 wt % | 4.0 | + | 0.90 | A | B |
| Ex. 3-2 | Aluminum nitrate | 2.5 wt % | 4.0 | + | 0.86 | B | B |
| Comp. Ex. 3-1 | — | 0 wt % | 4.0 | + | 0.38 | C | A |
| Comp. Ex. 3-2 | — | 0 wt % | 4.0 | + | 0.54 | B | A |
| Comp. Ex. 3-3 | Aluminum nitrate | 5 wt % | 4.0 | + | 0.76 | B | B |

As is clear from Table 4, in Examples 3-1 and 3-2 in which the polishing compositions obtained by mixing alumina, polyvinylpyrrolidone, 0.01% by mass or more and 15% by mass or less of the monovalent acid-aluminum salt, and water were used, the polishing removal rates exceeded 0.8 μm/min and few scratches were observed. In contrast, Comparative Examples 3-1 to 3-3 free from polyvinylpyrrolidone and/or the monovalent acid-aluminum salt had results that the polishing removal rate was low or a large number of scratches were observed and the surface properties were not good.

### Example 4

In Examples 4-1 and 4-2 and Comparative Examples 4-1 to 4-6, polishing compositions were prepared by mixing alumina or silica, water-soluble polymers, polishing removal accelerators shown in Table 5, and water in the same manner as in Example 1 and Example 2. A polyimide resin was polished under the following polishing conditions using each of the obtained polishing compositions.

Polishing object: Polyimide resin (Rockwell hardness M50)

Polishing machine: EJ-380IN manufactured by ENGIS JAPAN CORPORATION

Polishing pad: Suede pad N17 manufactured by Fujibo Ehime Co., Ltd.

Polishing pressure: 200 g/cm² (14.7 kPa)

Polishing time: 30 minutes

Used amount of polishing composition: 45 ml

Supply flow amount of polishing composition: 15 ml/min

The alumina or silica, polyvinylpyrrolidone, monovalent acid-aluminum salt contents in each polishing composition, the volume-based average particle diameter of the alumina, the weight average molecular weight of the water-soluble polymer, the zeta potential and the pH of each polishing composition are shown in Table 5 as with Table 1.

The polishing removal rate of the polyimide resin was calculated from a weight difference before and after the polishing of the polyimide resin with an electronic balance XS205 manufactured by METTLER TOLEDO Co., Ltd. The obtained polishing removal rate values are shown in Table 5. The surface properties were evaluated by observing the polished surface of the polyimide resin after the polishing with a laser microscope VK-X200 manufactured by KEYENCE CORPORATION, with 20× objective and 20× ocular lenses, and at an angle of observation of 528×705 μm. A case where no scratches are observed on the surface is indicated as A, a case where the number of scratches at the above-described viewing angle is 1 to 2 is indicated as B, a case where the number of scratches is 3 to 10 is indicated as C, and a case where the number of scratches is 11 or more is indicated as D. The stability of the polishing compositions was evaluated in the same manner as in Example 1.

TABLE 5

| | | Abrasives | | | | | | |
|---|---|---|---|---|---|---|---|---|
| | | | | Particle | | Water-soluble polymer | | |
| | Polishing object | Type | Content | diameter | | Compound name | Content | |
| Ex. 4-1 | Polyimide resin | Alumina | 12.4 wt % | 0.25 | um | Polyvinylpyrrolidone | 0.1 | wt % |
| | | | | | | (Mw: 45,000) | | |
| Ex. 4-2 | Polyimide resin | Colloidal | 17.5 wt % | 0.2 | um | Polyvinylpyrrolidone | 0.1 | wt % |
| | | silica | | | | (Mw: 45,000) | | |
| Comp. Ex. 4-1 | Polyimide resin | Alumina | 12.4 wt % | 0.25 | um | — | 0 | wt % |
| Comp. Ex. 4-2 | Polyimide resin | Alumina | 12.4 wt % | 0.25 | um | Polyvinylpyrrolidone | 0.1 | wt % |
| | | | | | | (Mw: 45,000) | | |
| Comp. Ex. 4-3 | Polyimide resin | Alumina | 12.4 wt % | 0.25 | um | — | 0 | wt % |
| Comp. Ex. 4-4 | Polyimide resin | Colloidal | 17.5 wt % | 0.2 | um | — | 0 | wt % |
| | | silica | | | | | | |
| Comp. Ex. 4-5 | Polyimide resin | Colloidal | 17.5 wt % | 0.2 | um | Polyvinylpyrrolidone | 0.1 | wt % |
| | | silica | | | | (Mw: 45,000) | | |
| Comp. Ex. 4-6 | Polyimide resin | Colloidal | 17.5 wt % | 0.2 | um | — | 0 | wt % |
| | | silica | | | | | | |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 4-1 | Aluminum nitrate | 5 wt % | 3.2 | + | 0.11 | A | A |
| Ex. 4-2 | Aluminum nitrate | 5 wt % | 3.2 | + | 0.16 | A | A |
| Comp. Ex. 4-1 | — | 0 wt % | 3.2 | + | 0.02 | C | A |
| Comp. Ex. 4-2 | — | 0 wt % | 3.2 | + | 0.04 | C | A |
| Comp. Ex. 4-3 | Aluminum nitrate | 5 wt % | 3.2 | + | 0.05 | C | A |
| Comp. Ex. 4-4 | — | 0 wt % | 3.2 | + | 0.03 | B | A |
| Comp. Ex. 4-5 | — | 0 wt % | 3.2 | 0 | 0.04 | B | A |
| Comp. Ex. 4-6 | Aluminum nitrate | 5 wt % | 3.2 | − | 0.07 | B | A |

As is clear from Table 5, in Examples 4-1 and 4-2 in which the polishing compositions obtained by mixing alumina or silica, polyvinylpyrrolidone, 0.01% by mass or more and 15% by mass or less of the monovalent acid-aluminum salt, and water were used, the polishing removal rates exceeded 0.1 μm/min, and few scratches were observed. In contrast, Comparative Examples 4-1 to 4-6 free from polyvinylpyrrolidone and/or the monovalent acid-aluminum salt had results that the polishing removal rate was low and the evaluation of scratches was also slightly inferior to Examples 4-1 and 4-2.

### Example 5

In Example 5-1 and Comparative Examples 5-1 to 5-3, polishing compositions were prepared by mixing alumina, water-soluble polymers, polishing removal accelerators shown in Table 6, and water in the same manner as in Example 1. Polytetrafluoroethylene (PTFE) was polished under the following polishing conditions using each of the obtained polishing compositions.

Polishing object: Polytetrafluoroethylene (Rockwell hardness R20)

Polishing machine: EJ-380IN manufactured by ENGIS JAPAN CORPORATION

Polishing pad: Suede pad N17 manufactured by Fujibo Ehime Co., Ltd.

Polishing pressure: 150 g/cm² (14.7 kPa) Polishing time: 3 minutes

Used amount of polishing composition: 45 ml

Supply flow amount of polishing composition: 15 ml/min

The polishing removal rate of the polytetrafluoroethylene was calculated from a weight difference before and after the polishing of the polytetrafluoroethylene with an electronic balance XS205 manufactured by METTLER TOLEDO Co., Ltd. The obtained polishing removal rate values are shown in Table 4. The surface properties were evaluated by observing the polished surface of the polytetrafluoroethylene after the polishing with a laser microscope VK-X200 manufactured by KEYENCE CORPORATION, with 20× objective and 20× ocular lenses, and at an angle of observation of 528×705 μm. A case where no scratches are observed on the surface is indicated as A, a case where the number of scratches at the above-described viewing angle is 1 to 2 is indicated as B, a case where the number of scratches is 3 to 10 is indicated as C, and a case where the number of scratches is 11 or more is indicated as D. The stability of the polishing compositions was evaluated in the same manner as in Example 1.

TABLE 6

| | | Abrasives | | | | |
|---|---|---|---|---|---|---|
| | | | | Particle | Water-soluble polymer | |
| | Polishing object | Type | Content | diameter | Compound name | Content |
| Ex. 5-1 | PTFE | Alumina | 12.4 wt % | 0.25 um | Polyvinylpyrrolidone | 0.25 wt % |
| | | | | | (Mw: 45,000) | |
| Comp. Ex. 5-1 | PTFE | Alumina | 12.4 wt % | 0.25 um | — | 0 wt % |
| Comp. Ex. 5-2 | PTFE | Alumina | 12.4 wt % | 0.25 um | Polyvinylpyrrolidone | 0.25 wt % |
| | | | | | (Mw: 45,000) | |
| Comp. Ex. 5-3 | PTFE | Alumina | 12.4 wt % | 0.25 um | — | 0 wt % |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 5-1 | Aluminum nitrate | 5 wt % | 3.0 | + | 0.50 | A | A |
| Comp. Ex. 5-1 | — | 0 wt % | 3.0 | + | 0.30 | C | A |
| Comp. Ex. 5-2 | — | 0 wt % | 3.0 | + | 0.43 | D | A |
| Comp. Ex. 5-3 | Aluminum nitrate | 5 wt % | 3.0 | + | 0.44 | B | A |

As is clear from Table 6, in Example 5-1 in which the polishing composition obtained by mixing alumina, polyvinylpyrrolidone, 0.01% by mass or more and 15% by mass or less of the monovalent acid-aluminum salt, and water was used, the polishing removal rate was 0.50 μm/min or more and few scratches were observed. In contrast, Comparative Examples 5-1 to 5-3 free from polyvinylpyrrolidone and/or the monovalent acid-aluminum salt had results that the polishing removal rates were low or a large number of scratches were observed and the surface properties were not good.

### Example 6

In Example 6-1 and Comparative Examples 6-1 to 6-3, polishing compositions were prepared by mixing alumina, water-soluble polymers, polishing removal accelerators shown in Table 7, and water in the same manner as in Example 1. An epoxy resin was polished under the following polishing conditions using each of the obtained polishing compositions.

Polishing object: Epoxy resin (Rockwell hardness M80-110)

Polishing machine: EJ-380IN manufactured by ENGIS JAPAN CORPORATION

Polishing pad: Suede pad N17 manufactured by Fujibo Ehime Co., Ltd.

Polishing pressure: 150 g/cm² (14.7 kPa)

Polishing time: 3 minutes

Used amount of polishing composition: 45 ml

Supply flow amount of polishing composition: 15 ml/min

The polishing removal rate of the epoxy resin was calculated from a weight difference before and after the polishing of the epoxy resin with an electronic balance XS205 manufactured by METTLER TOLEDO Co., Ltd. The obtained polishing removal rate values are shown in Table 4. The surface properties were evaluated by observing the polished surface of the epoxy resin after the polishing with a laser microscope VK-X200 manufactured by KEYENCE CORPORATION, with 20× objective and 20× ocular lenses, and at an angle of observation of 528×705 μm. A case where no scratches are observed on the surface is indicated as A, a case where the number of scratches at the above-described viewing angle is 1 to 2 is indicated as B, a case where the number of scratches is 3 to 10 is indicated as C, and a case where the number of scratches is 11 or more is indicated as D. The stability of the polishing compositions was evaluated in the same manner as in Example 1.

TABLE 7

| | | Abrasives | | | | |
|---|---|---|---|---|---|---|
| | | | | Particle | Water-soluble polymer | |
| | Polishing object | Type | Content | diameter | Compound name | Content |
| Ex. 6-1 | Epoxy resin | Alumina | 12.4 wt % | 0.25 um | Polyvinylpyrrolidone | 0.25 wt % |
| | | | | | (Mw: 45,000) | |
| Comp. Ex. 6-1 | Epoxy resin | Alumina | 12.4 wt % | 0.25 um | — | 0. wt % |
| Comp. Ex. 6-2 | Epoxy resin | Alumina | 12.4 wt % | 0.25 um | Polyvinylpyrrolidone | 0.25 wt % |
| | | | | | (Mw: 45,000) | |
| Comp. Ex. 6-3 | Epoxy resin | Alumina | 12.4 wt % | 0.25 um | — | 0 wt % |

| | | | | | Polishing | | |
|---|---|---|---|---|---|---|---|
| | Polishing removal accelerator | | | Zeta | removal rate | | |
| | Compound name | Content | pH | potential | (um/min) | Scratch | Stability |
| Ex. 6-1 | Aluminum nitrate | 5 wt % | 3.2 | + | 0.88 | A | A |
| Comp. Ex. 6-1 | — | 0 wt % | 3.2 | + | 0.07 | C | — |
| Comp. Ex. 6-2 | — | 0 wt % | 3.2 | + | 0.20 | C | — |
| Comp. Ex. 6-3 | Aluminum nitrate | 5 wt % | 3.2 | + | 0.49 | B | — |

As is clear from Table 7, in Example 6-1 in which the polishing composition obtained by mixing alumina, polyvinylpyrrolidone, 0.01% by mass or more and 15% by mass or less of the monovalent acid-aluminum salt, and water was used, the polishing removal rate exceeded 0.80 μm/min and few scratches were observed. In contrast, in Comparative Examples 6-1 to 6-3 free from polyvinylpyrrolidone and/or the monovalent acid-aluminum salt had results that the polishing removal rates were low or a large number of scratches were observed and the surface properties were not good.

1. A polishing composition comprising:
abrasives;
0.01% by mass or more and 15% by mass or less of a monovalent acid-aluminum salt;
a pyrrolidone compound or a caprolactam compound; and
water, wherein
a pH is 7.0 or less.

2. The polishing composition according to claim 1, wherein the pH is 4.5 or less.

3. The polishing composition according to claim 1, wherein the pH is 3.4 or less.

4. The polishing composition according to claim 1, wherein the abrasives contain alumina.

5. The polishing composition according to claim 4, wherein a volume-based average particle diameter of the alumina is 0.1 μm or more and 0.5 μm or less.

6. The polishing composition according to claim 4, wherein a BET specific surface area of the alumina is 10 m²/g or more and 50 m²/g or less.

7. The polishing composition according to claim 4, wherein an α-conversion rate of the alumina is 50% or more.

8. The polishing composition according to claim 1, wherein the abrasives contain silica.

9. The polishing composition according to claim 8, wherein
a volume-based average particle diameter of the silica is 0.02 μm or more and 0.3 μm or less.

10. The polishing composition according to claim 1, wherein
a content of the monovalent acid-aluminum salt is 5% by mass or more and 15% by mass or less.

11. The polishing composition according to claim 1, wherein
the monovalent acid-aluminum salt is at least one selected from aluminum nitrate or aluminum chloride.

12. The polishing composition according to claim 1, wherein the polishing composition is used for polishing a synthetic resin.

13. A method for polishing a synthetic resin comprising:
polishing a synthetic resin using the polishing composition according to claim 1.

14. The polishing composition according to claim 2, wherein
the abrasives contain alumina.

15. The polishing composition according to claim 3, wherein
the abrasives contain alumina.

16. The polishing composition according to claim 5, wherein
a BET specific surface area of the alumina is 10 m²/g or more and 50 m²/g or less.

17. The polishing composition according to claim 5, wherein
an α-conversion rate of the alumina is 50% or more.

18. The polishing composition according to claim 6, wherein
an α-conversion rate of the alumina is 50% or more.

19. The polishing composition according to claim 2, wherein
the abrasives contain silica.

20. The polishing composition according to claim 3, wherein
the abrasives contain silica.
